(19) United States
(12) Patent Application Publication
(10) Pub. No.: US 2019/0293161 A1
(43) Pub. Date: Sep. 26, 2019

(54) DIFFERENTIAL

(71) Applicant: JTEKT Corporation, Osaka-shi (JP)

(72) Inventors: Tadashi Yoshisaka, Kariya-shi (JP); He Jin, Kariya-shi (JP); Yasunori Kamitani, Fujimi-shi (JP)

(73) Assignee: JTEKT Corporation, Osaka-shi (JP)

(21) Appl. No.: 16/358,067

(22) Filed: Mar. 19, 2019

(30) Foreign Application Priority Data
Mar. 20, 2018 (JP) 2018-053343

(51) Int. Cl. F16H 48/24; F16D 27/118; F16H 48/11

(52) U.S. Cl. CPC F16H 48/24; F16H 2048/346; F16H 48/11; F16D 27/118

(57) ABSTRACT

A differential includes a clutch ring and an actuator. The clutch ring restricts rotation of a first side gear relative to a differential case. The actuator axially moves the clutch ring. The actuator includes an electromagnetic coil, a yoke, and an armature. The armature slides on an outer peripheral surface of the electromagnetic coil so as to move axially. The yoke includes a side wall facing an axial end face of the electromagnetic coil. At least one of an outer peripheral surface of the side wall and an inner peripheral surface of a cylindrical portion of the armature is provided with an inclined portion to prevent one of the outer peripheral surface and the inner peripheral surface from coming into contact with the other one of the outer peripheral surface and the inner peripheral surface.

### INCORPORATION BY REFERENCE

The disclosure of Japanese Patent Application No. 2018-053343 filed on Mar. 20, 2018, including the specification, drawings and abstract, is incorporated herein by reference in its entirety.

### BACKGROUND OF THE INVENTION

### 1. Field of the Invention

The invention relates generally to differentials. More particularly, the invention relates to a differential that is able to differentially output, from a pair of output rotators, a driving force input to a case.

### 2. Description of the Related Art

A vehicle differential known in the related art may be able to differentially output, from a pair of output rotators, a driving force input to a case. Such a differential may include a movable member disposed such that the movable member is axially movable inside a case by an actuator. Movement of the movable member may enable switching between operation modes of the differential. The applicants of the invention disclose a differential of this type in Japanese Patent Application Publication No. 2017-187137 (JP 2017-187137 A).

The differential disclosed in JP 2017-187137 A includes: right and left side gears serving as a pair of output rotators; a plurality of pinion gears in mesh with the right and left side gears; a pinion shaft pivotally supporting the pinion gears; a slider serving as a movable member including an engagement portion that comes into engagement with the pinion shaft; and an actuator to axially move the slider. An axial end of the slider is provided with a first meshing portion. A portion of a differential case axially facing the first meshing portion is provided with a second meshing portion. The actuator moves the slider between a coupling position where the first and second meshing portions are in mesh with each other and a non-coupling position where the first and second meshing portions are out of mesh with each other.

The actuator includes: an electromagnetic coil to produce a magnetic force; a yoke supporting the electromagnetic coil; and an armature that is axially moved by the magnetic force of the electromagnetic coil. The electromagnetic coil is formed by molding a winding with a resin portion such that the electromagnetic coil is rectangular in cross section. The yoke and the armature are each made of a soft magnetic metal. The yoke is L-shaped in cross section. The yoke includes a side wall facing an axial end face of the electromagnetic coil. The armature includes a cylindrical portion disposed outward of the electromagnetic coil and the side wall of the yoke. The inner peripheral surface of the cylindrical portion slides on the outer peripheral surface of the resin portion of the electromagnetic coil, so that the armature moves axially. A presser is disposed between the armature and the slider. A moving force generated by the actuator is transmitted to the slider through the presser.

The vehicle differential configured as described above requires setting the outer diameter of the resin portion of the electromagnetic coil and the inner diameter of the cylindrical portion of the armature in light of the fact that the differential is used in a high temperature environment. The thermal expansion coefficient of the resin portion of the electromagnetic coil is higher than the thermal expansion coefficient of the armature made of a soft magnetic metal. This makes it necessary to set the dimensions of the cylindrical portion of the armature and the resin portion of the electromagnetic coil such that the inner diameter of the cylindrical portion of the armature is larger than the outer diameter of the resin portion of the electromagnetic coil under high temperature conditions.

Setting the dimensions in the manner described above, however, increases a gap between the resin portion of the electromagnetic coil and the cylindrical portion of the armature under low temperature conditions (e.g., at zero degrees or less), making it likely that the armature will incline relative to the electromagnetic coil. The inclination of the armature may cause the cylindrical portion of the armature to come into contact with the outer peripheral surface of the side wall of the yoke. This may slow a motion of the armature and thus produce adverse effects, such as a reduction in operating speed. Reducing the outer diameter of the side wall of the yoke makes it possible to prevent the cylindrical portion of the armature from coming into contact with the side wall of the yoke. Reducing the outer diameter of the side wall of the yoke, however, increases magnetic resistance between the yoke and the armature. This unfortunately reduces the magnetic force exerted on the armature when the armature is moved from its initial position upon energization of the magnetic coil.

### SUMMARY OF THE INVENTION

An object of the invention is to provide a differential configured such that a movable member disposed inside a case is moved by an actuator including an armature that slides on the outer peripheral surface of a resin portion of a magnetic coil supported by a yoke. The differential is able to limit a reduction in magnetic force exerted on the armature while preventing the armature from coming into contact with the yoke.

A differential according to an aspect of the invention includes a case, a plurality of rotative elements, a movable member, and an actuator. The case rotates around a rotation axis upon receiving a driving force from a driving source. The rotative elements include a pair of output rotators housed in the case. The movable member is disposed such that the movable member is axially movable along the rotation axis inside the case. The movable member is axially movable toward one side so as to restrict rotation of one of the rotative elements relative to the case. The actuator axially moves the movable member. The differential differentially outputs, from the pair of output rotators, the driving force input to the case. The actuator includes an electromagnetic coil, a yoke, and an armature. The electromagnetic coil includes a winding and a resin portion. The winding is molded with the resin portion. The yoke supports the electromagnetic coil. The armature slides on an outer peripheral surface of the electromagnetic coil so as to move axially. The yoke includes a side wall including a lateral surface that faces one of axial end faces of the electromagnetic coil. The armature includes a cylindrical portion including an inner peripheral surface that faces the outer peripheral surface of the electromagnetic coil and an outer peripheral surface of the side wall. At least one of the outer peripheral surface of the side wall and the inner peripheral surface of the cylindrical portion is provided with an inclined portion inclined relative to a direction parallel to the rotation axis. The inclined portion restricts the one of the outer peripheral surface of the side wall and the inner peripheral surface of the cylindrical portion from coming into contact with the other one of the outer peripheral surface of the side wall and the inner peripheral surface of the cylindrical portion.

The differential according to the above aspect is configured such that the movable member disposed inside the case is moved by the actuator including the armature that slides on the outer peripheral surface of the resin portion of the magnetic coil supported by the yoke. The differential is able to limit a reduction in magnetic force exerted on the armature while preventing the armature from coming into contact with the yoke.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a cross-sectional view of a differential according to a first embodiment of the invention, illustrating a configuration example thereof;

FIG. 2 is an exploded perspective view of the differential;

FIG. 3 is an exploded perspective view of the differential, illustrating components thereof inside a differential case;

FIG. 4A is a perspective view of a clutch ring;

FIG. 4B is a perspective view of the clutch ring;

FIG. 5A is a cross-sectional view of an actuator in a non-operating state;

FIG. 5B is a partially enlarged view of the actuator illustrated in FIG. 5A;

FIG. 5C is a partially enlarged view of the actuator illustrated in FIG. 5A;

FIG. 6A is a cross-sectional view of the actuator in an operating state;

FIG. 6B is a partially enlarged view of the actuator illustrated in FIG. 6A;

FIG. 6C is a partially enlarged view of the actuator illustrated in FIG. 6A;

FIG. 7A is a partial cross-sectional view of an actuator of a differential according to a second embodiment of the invention, with an electromagnetic coil being not energized; and

FIG. 7B is a partial cross-sectional view of the actuator of the differential according to the second embodiment of the invention, with the electromagnetic coil being energized.

### DETAILED DESCRIPTION OF EMBODIMENTS

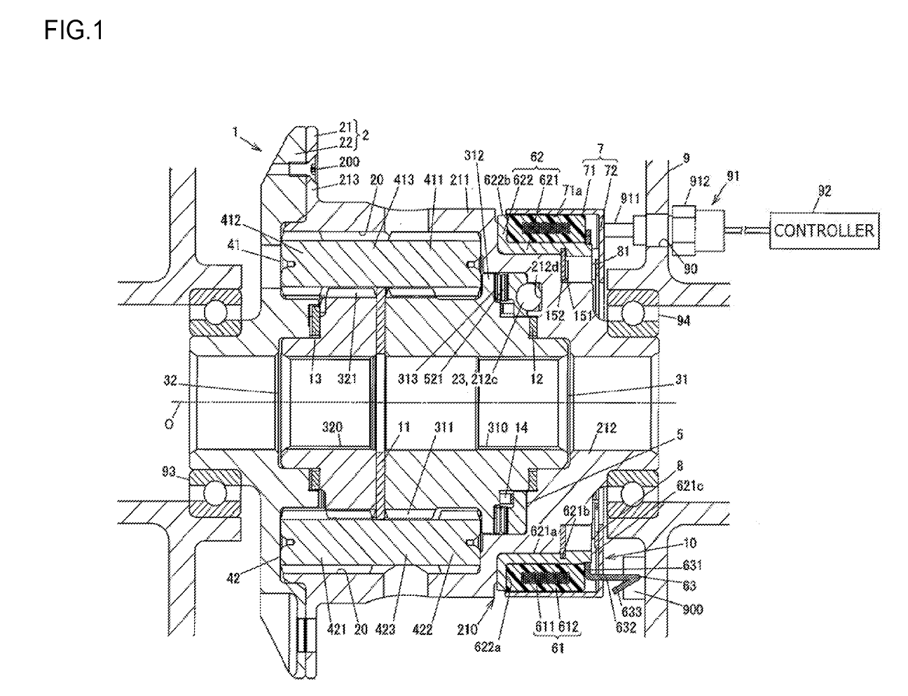

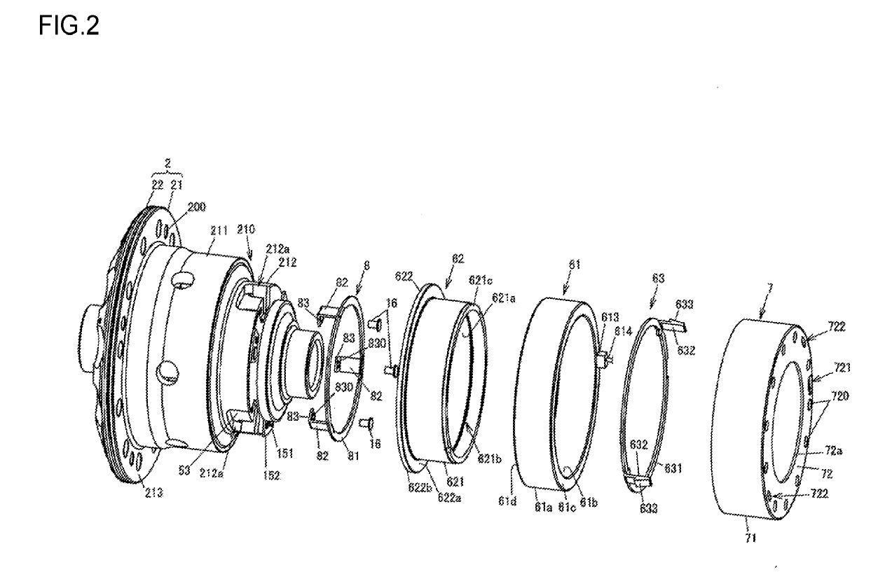

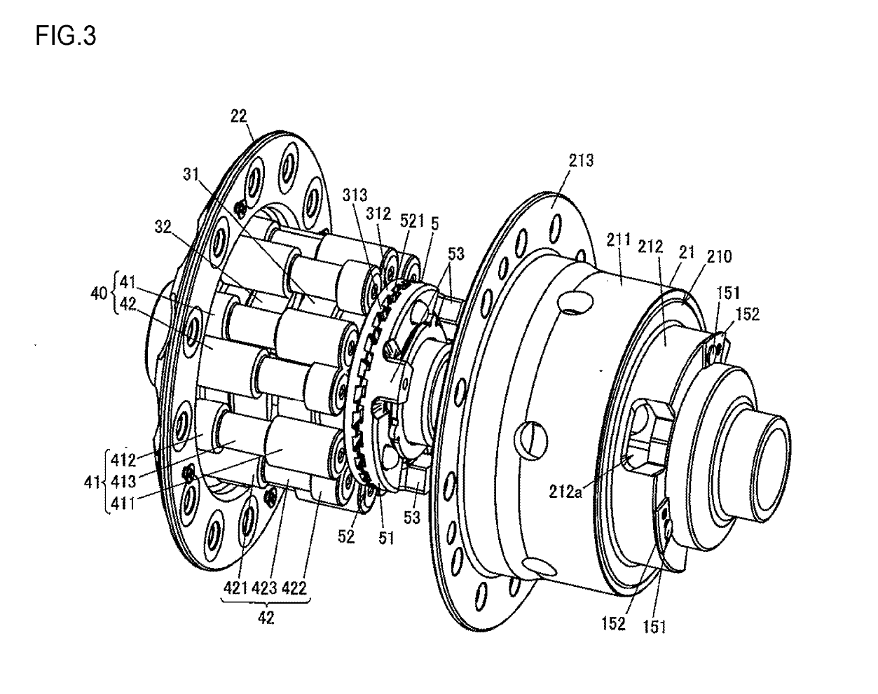

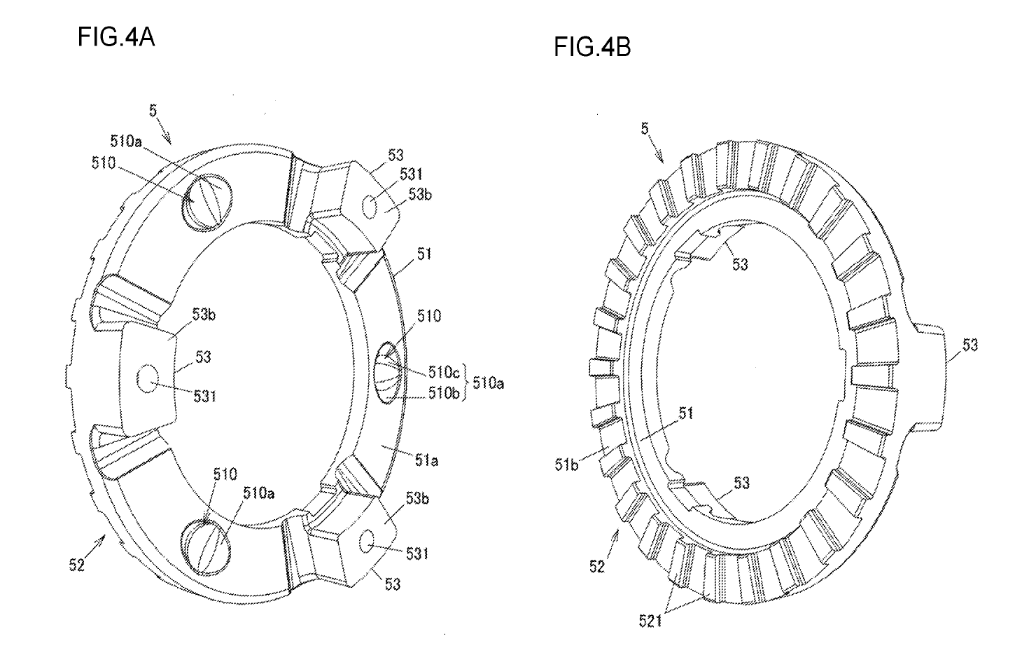

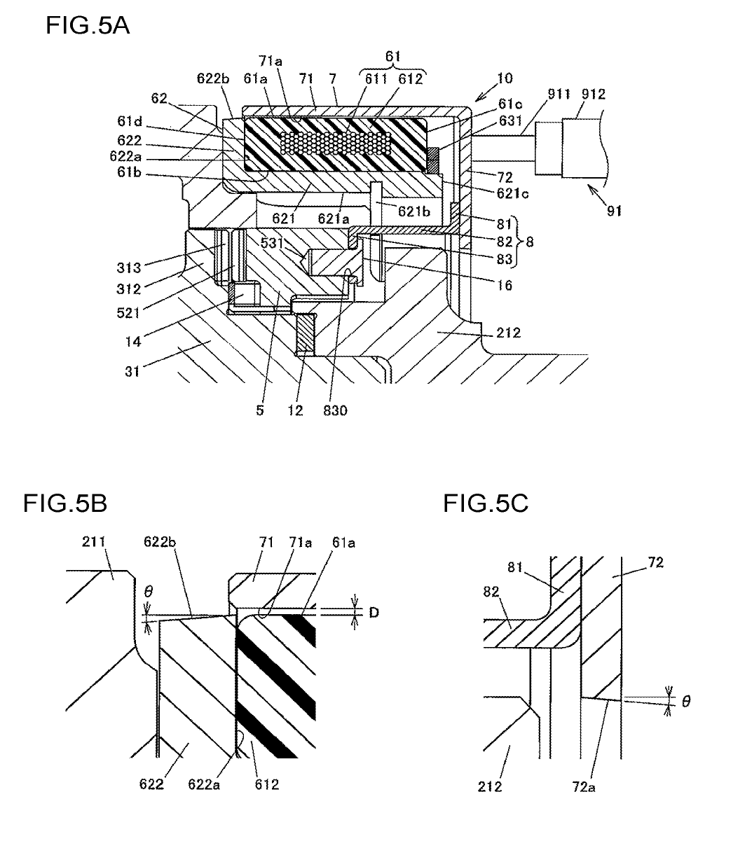

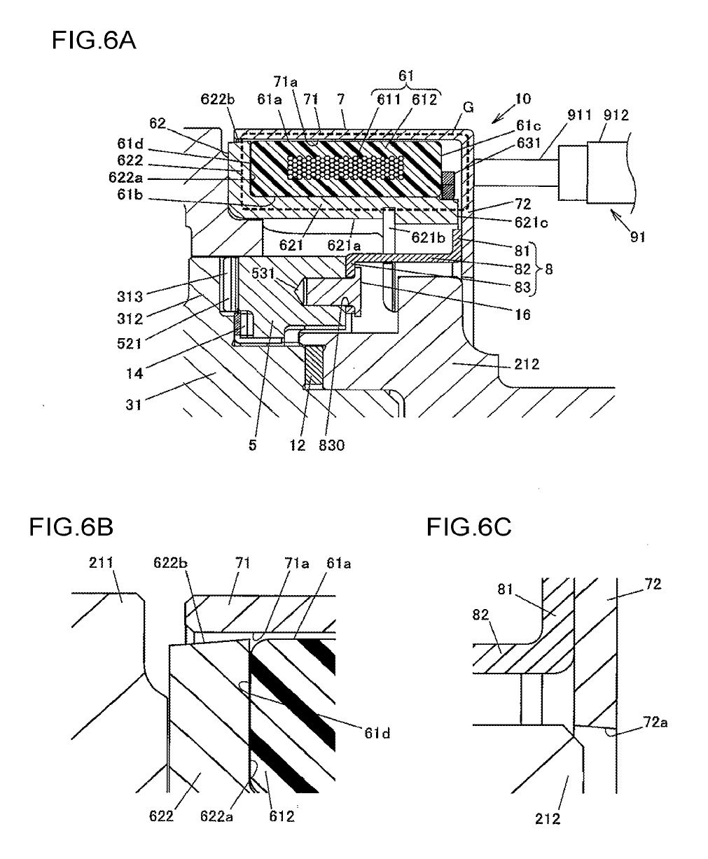

A first embodiment of the invention will be described with reference to FIGS. 1 to 6C. FIG. 1 is a cross-sectional view of a differential 1 according to a first embodiment of the invention, illustrating a configuration example thereof. FIG. 2 is an exploded perspective view of the differential 1. FIG. 3 is an exploded perspective view of the differential 1, illustrating components thereof inside a differential case 2. FIGS. 4A and 4B are each a perspective view of a clutch ring 5. FIG. 5A is a cross-sectional view of an actuator 10 in a non-operating state. FIGS. 5B and 5C are each a partially enlarged view of the actuator 10 illustrated in FIG. 5A. FIG. 6A is a cross-sectional view of the actuator 10 in an operating state. FIGS. 6B and 6C are each a partially enlarged view of the actuator 10 illustrated in FIG. 6A.

The differential 1 is used to differentially distribute a driving force from a driving source (such as an engine or an electric motor) of a vehicle to a pair of driving shafts. More specifically, the differential 1 according to the present embodiment is used as a differential to distribute a driving force from a driving source, for example, to right and left wheels. The differential 1 distributes an input driving force to right and left drive shafts (i.e., a pair of first and second driving shafts).

The differential 1 includes the differential case 2, a first side gear 31, a second side gear 32, a plurality of pinion gear sets 40, the clutch ring 5, and the actuator 10. The differential case 2 is a case that is supported by a differential carrier 9 secured to a vehicle body and is rotated around a rotation axis O. The first and second side gears 31 and 32 are a pair of output rotators housed in the differential case 2. Each of the pinion gear sets 40 includes a first pinion gear 41 and a second pinion gear 42 in mesh with each other. The clutch ring 5 is a movable member disposed to be axially movable along the rotation axis O inside the differential case 2. The actuator 10 axially moves the clutch ring 5 with respect to the differential case 2.

The differential carrier 9 has a position sensor 91 attached thereto. The position sensor 91 outputs an electric signal to control the actuator 10. The differential carrier 9 is provided with an attachment hole 90 through which the position sensor 91 is attached to the differential carrier 9. The electric signal output from the position sensor 91 is transmitted to a controller 92. The controller 92 controls the actuator 10 in accordance with the electric signal from the position sensor 91. Lubricating oil having a viscosity suitable for gear lubrication is enclosed in the differential carrier 9. The differential 1 is used in an environment where the differential 1 is lubricated with the lubricating oil.

The first and second side gears 31 and 32 each have a tubular shape. The first side gear 31 includes an inner peripheral surface provided with a spline-fitted portion 310. The first driving shaft is coupled to the spline-fitted portion 310 such that the first driving shaft is non-rotatable relative to the first side gear 31. The second side gear 32 includes an inner peripheral surface provided with a spline-fitted portion 320. The second driving shaft is coupled to the spline-fitted portion 320 such that the second driving shaft is non-rotatable relative to the second side gear 32.

The differential case 2 is made of a ferrous alloy. The differential case 2 is rotatably supported by the differential carrier 9 via a pair of bearings 93 and 94. The differential case 2, the first side gear 31, and the second side gear 32 are disposed such that the differential case 2, the first side gear 31, and the second side gear 32 are rotatable relative to each other around the rotation axis O. As used herein, the term “axial” or “axially” refers to a direction parallel to the rotation axis O.

The differential case 2 is provided with a plurality of retaining holes 20 through which the first and second pinion gears 41 and 42 of the pinion gear sets 40 are rotatably retained. The first and second pinion gears 41 and 42 each revolve around the rotation axis O. The first and second pinion gears 41 and 42 are each rotatable around its central axis within an associated one of the retaining holes 20.

The first side gear 31 includes an outer peripheral surface provided with a gear wheel 311 including helical teeth. The second side gear 32 includes an outer peripheral surface provided with a gear wheel 321 including helical teeth. The gear wheel 311 and the gear wheel 321 have the same or substantially the same outer diameter. A center washer 11 is disposed between the first side gear 31 and the second side gear 32. A side washer 12 is disposed laterally of the first side gear 31. A side washer 13 is disposed laterally of the second side gear 32.

Each first pinion gear 41 integrally includes a long gear wheel 411, a short gear wheel 412, and a coupler 413 through which the long gear wheel 411 and the short gear wheel 412 are axially coupled to each other. Each second pinion gear 42 integrally includes a long gear wheel 421, a short gear wheel 422, and a coupler 423 through which the long gear wheel 421 and the short gear wheel 422 are axially coupled to each other.

The long gear wheel 411 of each first pinion gear 41 is in mesh with the gear wheel 311 of the first side gear 31 and the short gear wheel 422 of the associated second pinion gear 42. The short gear wheel 412 of each first pinion gear 41 is in mesh with the long gear wheel 421 of the associated second pinion gear 42. The long gear wheel 421 of each second pinion gear 42 is in mesh with the gear wheel 321 of the second side gear 32 and the short gear wheel 412 of the associated first pinion gear 41. The short gear wheel 422 of each second pinion gear 42 is in mesh with the long gear wheel 411 of the associated first pinion gear 41. In FIG. 3, helical teeth of these gear wheels are not illustrated.

Rotation of the first and second side gears 31 and 32 at the same speed causes the first and second pinion gears 41 and 42 to revolve in conjunction with the rotation of the differential case 2 without rotating within the retaining holes 20. Rotation of the first and second side gears 31 and 32 at different speeds when the vehicle makes a turn, for example, causes the first and second pinion gears 41 and 42 to revolve while rotating within the retaining holes 20. The driving force input to the differential case 2 is thus differentially distributed to the first and second side gears 31 and 32.

The first and second side gears 31 and 32 and the first and second pinion gears 41 and 42 are rotative elements disposed in the differential case 2 and rotatable relative to the differential case 2. Restricting rotation of any one of the rotative elements relative to the differential case 2 brings the differential 1 to a differential lock state where the first and second side gears 31 and 32 are non-rotatable relative to each other. In the present embodiment, the clutch ring 5 restricts rotation of the first side gear 31 relative to the differential case 2.

The clutch ring 5 is axially movable between a coupling position where the differential case 2 and the first side gear 31 are relatively non-rotatably coupled to each other and a non-coupling position where the differential case 2 and the first side gear 31 are rotatable relative to each other. The clutch ring 5 is movable from the non-coupling position to the coupling position toward an axial one side so as to restrict rotation of the first side gear 31 relative to the differential case 2. FIGS. 5A to 5C each illustrate the actuator 10, with the clutch ring 5 located at the non-coupling position. FIGS. 6A to 6C each illustrate the actuator 10, with the clutch ring 5 located at the coupling position.

The clutch ring 5 located at the coupling position restricts differential operations of the differential case 2 and the first side gear 31, so that the first and second pinion gears 41 and 42 are non-rotatable within the retaining holes 20. This restricts rotation of the second side gear 32 relative to the differential case 2. The clutch ring 5 is urged to the non-coupling position by a return spring 14 disposed between the clutch ring 5 and the first side gear 31. In one example, the return spring 14 includes a disc spring and a waved washer.

The actuator 10 includes an electromagnetic coil 61, a yoke 62, a stopper ring 63, an armature 7, and a presser 8. The electromagnetic coil 61 is provided by molding a winding 611 with a resin portion 612. The yoke 62 supports the electromagnetic coil 61. The stopper ring 63 prevents disconnection of the electromagnetic coil 61 from the yoke 62 and prevents rotation of the yoke 62 relative to the differential carrier 9. The armature 7 slides on an outer peripheral surface 61a of the electromagnetic coil 61 so as to move axially. The presser 8 axially moves together with the armature 7 so as to press the clutch ring 5.

As enlargedly illustrated in FIGS. 5A and 6A, the electromagnetic coil 61 has a rectangular cross-sectional shape along the rotation axis O, with the winding 611 disposed centrally in the electromagnetic coil 61. The outer peripheral surface 61a, inner peripheral surface 61b, and first and second axial end faces 61c and 61d of the electromagnetic coil 61 are defined by the resin portion 612. As illustrated in FIG. 2, the electromagnetic coil 61 is provided with a boss 613 protruding from the first axial end face 61c. An electric wire 614 through which an exciting current is supplied to the winding 611 is extended out of the boss 613. The controller 92 supplies the exciting current to the winding 611 of the electromagnetic coil 61 through the electric wire 614. The supply of the exciting current to the winding 611 produces a magnetic flux in a magnetic path G (see FIG. 6A) defined mainly through the yoke 62 and the armature 7. A portion of the magnetic flux leaks from the yoke 62 and flows through the differential case 2.

The yoke 62 is made of a soft magnetic metal, such as low carbon steel. The yoke 62 integrally includes a cylindrical inner tubular portion 621 and a side wall 622. The inner tubular portion 621 covers from inside the inner peripheral surface 61b of the electromagnetic coil 61. The side wall 622 is protruded outward from an axial end of the inner tubular portion 621. The side wall 622 includes a lateral surface 622a facing the second axial end face 61d of the electromagnetic coil 61. The inner diameter of the inner tubular portion 621 is slightly larger than the outer diameter of a portion of the differential case 2 facing an inner peripheral surface 621a of the inner tubular portion 621. The differential case 2 is thus rotatable relative to the yoke 62 whose rotation is prevented by the differential carrier 9.

The inner peripheral surface 621a of the inner tubular portion 621 is provided with an annular recess 621b. Plates 152 each made of a non-magnetic material secured to the differential case 2 by a press-fitted pin 151 are fitted to the annular recess 621b. In the present embodiment, the number of plates 152 is three. Fitting the plates 152 to the annular recess 621b restricts axial movement of the yoke 62 relative to the differential case 2. The axial width of the annular recess 621b is slightly larger than the thickness of each plate 152 such that no rotational resistance occurs between the differential case 2 and the yoke 62 during rotation of the differential case 2.

The stopper ring 63 is made of a non-magnetic metal, such as austenitic stainless steel. The stopper ring 63 integrally includes: an annular portion 631 secured to the yoke 62; a pair of protrusions 632 axially protruding from two circumferential locations on the annular portion 631; and folded portions 633 provided by folding ends of the protrusions 632 at acute angles. The annular portion 631 faces the first axial end face 61c of the electromagnetic coil 61. The annular portion 631 is secured to an end of the inner tubular portion 621 of the yoke 62 located opposite to the side wall 622. The protrusions 632 of the stopper ring 63 are locked by locking portions 900 (see FIG. 1) of the differential carrier 9 so as to prevent rotation of the stopper ring 63. The differential carrier 9 includes two locking portions 900 each configured to lock an associated one of the protrusions 632. In FIG. 1, one of the locking portions 900 is illustrated.

The armature 7 is made of a soft magnetic metal, such as low carbon steel. The armature 7 integrally includes a cylindrical portion 71 disposed around the electromagnetic coil 61, and an annular plate 72 extending radially inward from an axial end of the cylindrical portion 71. The cylindrical portion 71 includes an inner peripheral surface 71a that faces the outer peripheral surface 61a of the electromagnetic coil 61 and an outer peripheral surface 622b of the side wall 622 of the yoke 62, with gaps created between the inner peripheral surface 71a and the outer peripheral surface 61a and between the inner peripheral surface 71a and the outer peripheral surface 622b. The annular plate 72 axially faces the first axial end face 61c of the electromagnetic coil 61, the annular portion 631 of the stopper ring 63, and an axial end face 621c of the inner tubular portion 621 of the yoke 62. Energizing the electromagnetic coil 61 moves the armature 7 such that the distance between the annular plate 72 of the armature 7 and the axial end face 621c of the yoke 62 decreases. During movement of the armature 7, the inner peripheral surface 71a of the cylindrical portion 71 of the armature 7 slides on the outer peripheral surface 61a of the electromagnetic coil 61.

The annular plate 72 of the armature 7 is provided with oil holes 720, a first through hole 721, and two second through holes 722. Lubricating oil flows through the oil holes 720. In the example illustrated in FIG. 2, the number of oil holes 720 is 11. The boss 613 of the electromagnetic coil 61 is inserted through the first through hole 721. The protrusions 632 of the stopper ring 63 are each inserted through an associated one of the second through holes 722. The protrusions 632 of the stopper ring 63 pass through the second through holes 722. This prevents rotation of the armature 7 relative to the differential carrier 9 and causes the folded portions 633 to prevent disconnection of the armature 7 from the stopper ring 63.

The presser 8 is provided by press-molding a plate material made of a non-magnetic metal, such as austenitic stainless steel. The presser 8 integrally includes a ring-shaped annular abutment portion 81, three extended portions 82, and three secured portions 83. The abutment portion 81 abuts against the annular plate 72 of the armature 7. The extended portions 82 are axially extended from the annular abutment portion 81. Each of the secured portions 83 is protruded inward from an end of the associated extended portion 82 and secured to the clutch ring 5. The annular abutment portion 81 of the presser 8 slides on the annular plate 72 of the armature 7, so that the presser 8 rotates together with the differential case 2. The inner diameter of the annular plate 72 is smaller than the inner diameter of the annular abutment portion 81. An inner end of the annular plate 72 is protruded radially inward of the annular abutment portion 81. The secured portions 83 are each provided with an insertion hole 830. Press-fitted pins 16 to secure the secured portions 83 to the clutch ring 5 are each inserted through an associated one of the insertion holes 830.

The differential case 2 includes a bottomed cylindrical case body 21 and a case lid 22. The case body 21 and the case lid 22 are secured to each other with a plurality of screws 200. The case lid 22 closes an opening defined in the case body 21. The case body 21 integrally includes a cylindrical portion 211, a bottom 212, and a flange 213. The cylindrical portion 211 retains the pinion gear sets 40 such that the pinion gear sets 40 are rotatable. The bottom 212 is extended inward from an end of the cylindrical portion 211. The flange 213 abuts against the case lid 22. A corner defined between the cylindrical portion 211 and the bottom 212 is provided with an annular recess 210. The electromagnetic coil 61 and the yoke 62 are disposed in the annular recess 210. A ring gear (not illustrated) is secured to the flange 213 of the case body 21. The differential case 2 receives, through the ring gear, a driving force from the driving source and thus rotates around the rotation axis O.

As illustrated in FIGS. 2 and 3, the bottom 212 of the case body 21 is provided with a plurality of insertion holes 212a into which the extended portions 82 and the secured portions 83 of the presser 8 are inserted. The insertion holes 212a axially pass through the bottom 212. Protrusions 53 of the clutch ring 5 (which will be described below) are each inserted into an associated one of the insertion holes 212a. The insertion of the protrusions 53 into the insertion holes 212a restricts rotation of the clutch ring 5 relative to the differential case 2. In the present embodiment, the number of insertion holes 212a is three, and the three insertion holes 212a are provided at regular intervals in the circumferential direction of the bottom 212.

As illustrated in FIG. 4, the clutch ring 5 integrally includes an annular circular plate 51, a meshing portion 52, and the protrusions 53. The circular plate 51 includes a first axial end face 51a and a second axial end face 51b. The first axial end face 51a of the circular plate 51 is provided with a plurality of cup-shaped recesses 510. The meshing portion 52 is provided on the second axial end face 51b of the circular plate 51 axially facing the first side gear 31. The protrusions 53 each have a trapezoidal columnar shape and are axially protruded from the first axial end face 51a of the circular plate 51.

The first axial end face 51a of the circular plate 51 axially faces the bottom 212 of the case body 21. A portion of each protrusion 53 is inserted into an associated one of the insertion holes 212a provided in the bottom 212 of the case body 21. The meshing portion 52 is provided with axially protruding meshing teeth 521. The meshing teeth 521 are provided on an outer portion of the second axial end face 51b of the circular plate 51. A portion of the second axial end face 51b located inward of the meshing portion 52 is a flat receiving surface. The return spring 14 abuts against the receiving surface, and the receiving surface thus receives an urging force of the return spring 14 that urges the clutch ring 5 to the non-coupling position.

As illustrated in FIG. 1, the first side gear 31 includes an annular wall 312 protruding outward of the gear wheel 311. The annular wall 312 is provided with meshing teeth 313 that mesh with the meshing teeth 521 of the clutch ring 5.

The clutch ring 5 is pressed by the armature 7 through the presser 8 and is thus moved to the coupling position. This causes the meshing teeth 521 of the meshing portion 52 to mesh with the meshing teeth 313 of the first side gear 31. The differential 1 thus enters the differential lock state. When the clutch ring 5 is moved to the non-coupling position by the urging force of the return spring 14, the meshing teeth 521 move out of mesh with the meshing teeth 313. This brings the differential 1 out of the differential lock state.

Each protrusion 53 includes an end face 53b provided with a press-fitting hole 531. The press-fitted pins 16 are each press-fitted into an associated one of the press-fitting holes 531. The press-fitted pins 16 are inserted through the insertion holes 830 of the secured portions 83 of the presser 8 and then press-fitted into the press-fitting holes 531. The clutch ring 5 is thus secured to the presser 8 such that the clutch ring 5 axially moves together with the presser 8.

Each cup-shaped recess 510 includes an inner surface 510a. Each inner surface 510a is a cam surface that rotates relative to the case body 21 and thus produces an axial cam thrust. Specifically, the inner surface 510a of each cup-shaped recess 510 includes a first inclined surface 510b inclined in a first direction relative to the circumferential direction of the clutch ring 5, and a second inclined surface 510c inclined in a second direction relative to the circumferential direction of the clutch ring 5. The bottom 212 of the case body 21 is provided with axially protruding protrusions 212c that abut against the inner surfaces 510a of the cup-shaped recesses 510. In the present embodiment, each protrusion 212c is a sphere 23 secured to the bottom 212. A portion of each sphere 23 is housed in an axial cavity 212d provided in the bottom 212 and is thus retained by the case body 21. Alternatively, the protrusions 212c may be integral with the bottom 212.

The circumferential width of each insertion hole 212a of the bottom 212 is larger than the circumferential width of each protrusion 53 of the clutch ring 5. The differential case 2 and the clutch ring 5 are rotatable relative to each other within a predetermined angular range responsive to the difference between the circumferential width of each insertion hole 212a and the circumferential width of each protrusion 53. The relative rotation of the differential case 2 and the clutch ring 5 causes each protrusion 212c of the bottom 212 to abut against the associated first inclined surface 510b or second inclined surface 510c. This produces a cam thrust to press the clutch ring 5 in a direction in which the meshing teeth 521 of the clutch ring 5 deeply mesh with the meshing teeth 313 of the first side gear 31.

The clutch ring 5 moves axially upon receiving a pressing force from the presser 8. This causes ends of the meshing teeth 521 to mesh with the meshing teeth 313 of the first side gear 31. The clutch ring 5 thus rotates relative to the differential case 2. This relative rotation produces a cam thrust that causes the meshing teeth 521 to more deeply mesh with the meshing teeth 313 of the first side gear 31.

The position sensor 91 detects an axial position of the clutch ring 5. The position sensor 91 includes a contact 911 and a support 912. The contact 911 is in elastic contact with the annular plate 72 of the armature 7. The support 912 supports the contact 911. The position sensor 91 indirectly detects the axial position of the clutch ring 5 in accordance with the position of the annular plate 72 of the armature 7. The support 912 is inserted through the attachment hole 90 of the differential carrier 9.

In moving the clutch ring 5 from the non-coupling position, the controller 92 supplies a large current to the electromagnetic coil 61. Upon determining that the clutch ring 5 has moved to a position where the meshing teeth 521 of the clutch ring 5 are in deep mesh with the meshing teeth 313 of the first side gear 31, the controller 92 reduces the current to be supplied to the electromagnetic coil 61. If the current to be supplied to the electromagnetic coil 61 is reduced, the clutch ring 5 would be maintained in a state where the meshing teeth 521 are in mesh with the meshing teeth 313 of the first side gear 31 owing to the cam thrust.

The thermal expansion coefficient of the resin portion 612 of the electromagnetic coil 61 is higher than the thermal expansion coefficient of the armature 7. The outer diameter of the electromagnetic coil 61 will thus increase at a higher rate than the inner diameter of the cylindrical portion 71 of the armature 7 when a peripheral temperature is high. This makes it necessary to set the outer diameter of the electromagnetic coil 61 and the inner diameter of the cylindrical portion 71 of the armature 7 such that a smooth axial movement of the armature 7 will not be prevented, i.e., such that the outer diameter of the electromagnetic coil 61 will not be larger than the inner diameter of the cylindrical portion 71 of the armature 7 in a high temperature environment.

FIGS. 5A to 5C and FIGS. 6A to 6C illustrate the actuator 10, with the electromagnetic coil 61 and the armature 7 disposed concentrically at room temperatures (e.g., at 25° C.). In this state, the outer peripheral surface 61a of the electromagnetic coil 61 and the inner peripheral surface 71a of the cylindrical portion 71 of the armature 7 have a gap D therebetween. In one example, the gap D has a size of 0.2 mm. The gap D decreases when the temperatures of the electromagnetic coil 61 and the armature 7 increase. The gap D increases when the temperatures of the electromagnetic coil 61 and the armature 7 decrease. The gap D at low temperatures may be twice or more as large as the gap D at room temperatures.

In this case, backlash of the armature 7 relative to the electromagnetic coil 61 will increase, making it likely that the armature 7 will incline relative to the electromagnetic coil 61 and the yoke 62. An increase in the inclination of the armature 7 makes it likely that an end of the cylindrical portion 71 of the armature 7 will come into contact with the outer peripheral surface 622b of the side wall 622 of the yoke 62 when the clutch ring 5 moves from the non-coupling position to the coupling position. The contact of the cylindrical portion 71 of the armature 7 with the outer peripheral surface 622b of the side wall 622 develops a short circuit of magnetic flux at the contact location. This disadvantageously prevents a smooth axial movement of the armature 7.

In order to prevent the end of the cylindrical portion 71 of the armature 7 from coming into contact with the outer peripheral surface 622b of the side wall 622 of the yoke 62 if the armature 7 inclines at low temperatures, the present embodiment involves providing an inclined portion on at least one of the outer peripheral surface 622b of the side wall 622 of the yoke 62 and the inner peripheral surface 71a of the cylindrical portion 71 of the armature 7. The inclined portion has an inclination relative to a direction parallel to the rotation axis O and prevents contact of one of the outer peripheral surface 622b and the inner peripheral surface 71a with the other one of the outer peripheral surface 622b and the inner peripheral surface 71a.

In the present embodiment, the inclined portion is provided on the outer peripheral surface 622b of the side wall 622 of the yoke 62. More specifically, as enlargedly illustrated in FIGS. 5B and 6B, an entirety of the outer peripheral surface 622b of the side wall 622 of the yoke 62 defines a tapered surface inclined such that the side wall 622 of the yoke 62 increases in diameter toward the electromagnetic coil 61. The tapered surface functions as the inclined portion. With the electromagnetic coil 61 being not energized, the end of the cylindrical portion 71 of the armature 7 radially faces a large-diameter end of the outer peripheral surface 622b of the yoke 62 (i.e., an end of the outer peripheral surface 622b of the yoke 62 adjacent to the electromagnetic coil 61). An angle θ formed between the outer peripheral surface 622b of the side wall 622 and an imaginary line parallel to the axial direction is one degree, for example. In FIGS. 5B and 6B, the angle θ is illustrated in an exaggerated manner for the sake of clarity.

Alternatively, a portion of the outer peripheral surface 622b of the side wall 622 of the yoke 62 may be an inclined portion. In this case, the outer peripheral surface 622b of the side wall 622 includes a parallel surface parallel to the axial direction, and a tapered surface continuous with the parallel surface. A portion of the outer peripheral surface 622b adjacent to the electromagnetic coil 61 defines the parallel surface. A portion of the outer peripheral surface 622b located opposite to the electromagnetic coil 61 defines the tapered surface. The tapered surface is an inclined surface inclined relative to the axial direction such that the side wall 622 gradually decreases in outer diameter toward an end of the side wall 622 located opposite to the electromagnetic coil 61.

In the present embodiment, the inner end of the annular plate 72 of the armature 7 is protruded radially inward of the annular abutment portion 81 of the presser 8. The annular plate 72 includes an inner peripheral surface 72a. The inner peripheral surface 72a is a tapered surface inclined such that the annular plate 72 increases in inner diameter toward the electromagnetic coil 61. The inner peripheral surface 72a of the annular plate 72 is thus inclined relative to the axial direction. Accordingly, if the armature 7 is inclined during axial movement of the armature 7 caused by the magnetic force of the electromagnetic coil 61, the inner end of the annular plate 72 would be prevented from coming into contact with an end of the bottom 212 of the case body 21.

At least a portion of the inner peripheral surface 72a of the annular plate 72 may be a tapered surface inclined such that the annular plate 72 increases in inner diameter toward the electromagnetic coil 61. This means that an entirety of the inner peripheral surface 72a does not necessarily have to be a tapered surface. Forming the entirety of the inner peripheral surface 72a of the annular plate 72 into a tapered surface, however, facilitates machining and makes it possible to reduce the distance between the inner end of the annular plate 72 and the end of the bottom 212 of the case body 21 while preventing the inner end of the annular plate 72 from coming into contact with the end of the bottom 212 of the case body 21.

The first embodiment described above involves providing the inclined portion on the outer peripheral surface 622b of the side wall 622 of the yoke 62 so as to prevent the armature 7 from coming into contact with the yoke 62. If the radial distance between the large-diameter end of the side wall 622 and the cylindrical portion 71 of the armature 7 is reduced, the armature 7 would be prevented from coming into contact with the yoke 62 when the armature 7 is inclined relative to the axial direction. This makes it possible to limit a reduction in magnetic force exerted on the armature 7 while precluding the armature 7 from coming into contact with the yoke 62.

In the present embodiment, the inner end of the annular plate 72 of the armature 7 is protruded radially inward of the annular abutment portion 81 of the presser 8. During rotation of the differential case 2, an entirety of a surface of the annular abutment portion 81 adjacent to the annular plate 72 slides on the annular plate 72. This prevents or reduces wearing of sliding contact regions of the annular abutment portion 81 and the annular plate 72, resulting in an increase in durability, and prevents or limits a wearing-induced reduction in accuracy of detecting the axial position of the clutch ring 5 by the position sensor 91.

In the present embodiment, the inner peripheral surface 72a of the annular plate 72 of the armature 7 is the tapered surface inclined such that the annular plate 72 increases in inner diameter toward the electromagnetic coil 61. Thus, if the distance between the inner end of the annular plate 72 and the end of the bottom 212 of the case body 21 is reduced, the inner end of the annular plate 72 would be prevented from coming into contact with the end of the bottom 212 of the case body 21. Accordingly, the axial movement of the armature 7 is also enabled by magnetic flux leaking from the yoke 62 to the case body 21, making it possible to increase the moving force of the actuator 10 that axially moves the clutch ring 5.

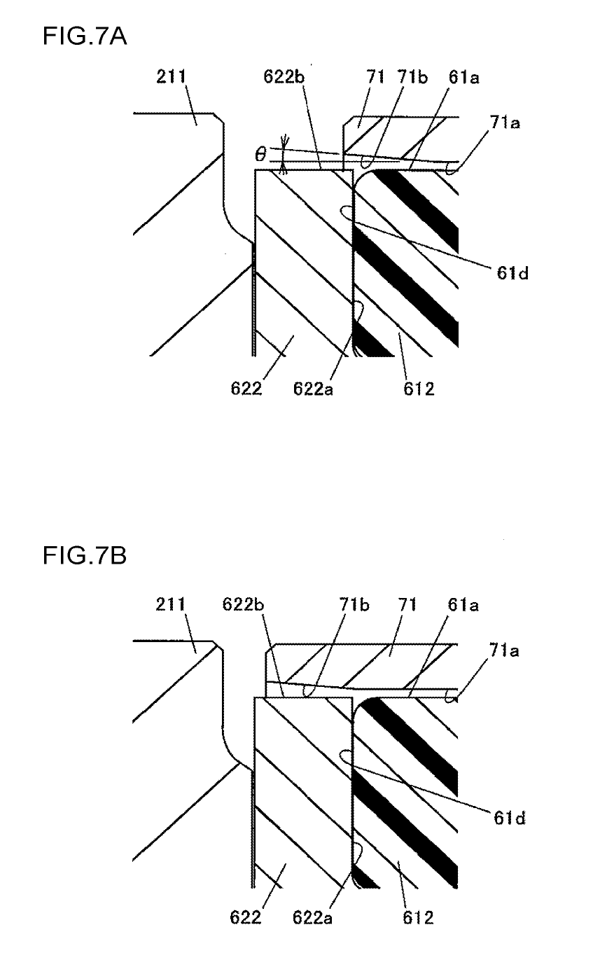

A second embodiment of the invention will be described below with reference to FIGS. 7A and 7B. The first embodiment has been described on the assumption that the outer peripheral surface 622b of the side wall 622 of the yoke 62 is provided with the inclined portion to prevent the armature 7 from coming into contact with the yoke 62. In the second embodiment, the inner peripheral surface 71a of the cylindrical portion 71 of the armature 7 is provided with an inclined portion to prevent the armature 7 from coming into contact with the yoke 62.

FIG. 7A illustrates a portion of the actuator 10 when the electromagnetic coil 61 is not energized and the clutch ring 5 is thus located at the non-coupling position. FIG. 7B illustrates the portion of the actuator 10 when the electromagnetic coil 61 is energized and the clutch ring 5 is thus located at the coupling position. A differential according to the second embodiment is similar in configuration to the differential 1 according to the first embodiment except the portion of the actuator 10 illustrated in FIGS. 7A and 7B.

As illustrated in FIGS. 7A and 7B, a portion of the inner peripheral surface 71a on an end of the cylindrical portion 71 of the armature 7 that radially faces the outer peripheral surface 622b of the side wall 622 of the yoke 62 is provided with a tapered surface 71b. The tapered surface 71b is inclined such that the cylindrical portion 71 increases in inner diameter toward an extremity of the cylindrical portion 71 located opposite to the annular plate 72. The tapered surface 71b is an inclined portion provided on the inner peripheral surface 71a of the cylindrical portion 71 of the armature 7 in order to prevent the cylindrical portion 71 of the armature 7 from coming into contact with the outer peripheral surface 622b of the side wall 622. Accordingly, the inclination of the tapered surface 71b prevents the armature 7 from coming into contact with the yoke 62.

In the example illustrated in FIGS. 7A and 7B, the outer peripheral surface 622b of the side wall 622 of the yoke 62 is a parallel surface parallel to the axial direction, such that the outer diameter of the side wall 622 is substantially equal to the outer diameter of the electromagnetic coil 61. Alternatively, the outer peripheral surface 622b of the side wall 622 may be a tapered surface similarly to the first embodiment. In other words, the inclination portion to prevent the armature 7 from coming into contact with the yoke 62 is preferably provided on at least one of the outer peripheral surface 622b of the side wall 622 of the yoke 62 and the inner peripheral surface 71a of the cylindrical portion 71 of the armature 7.

Similarly to the first embodiment, the second embodiment makes it possible to limit a reduction in magnetic force exerted on the armature 7 while precluding the armature 7 from coming into contact with the yoke 62 when the armature 7 inclines relative to the axial direction.

The invention may be modified as appropriate without departing from the spirit of the invention. Although the foregoing embodiments have been described on the assumption that the invention is applied to a differential including the first and second pinion gears 41 and 42 disposed in parallel to the rotation axis O, the application of the invention is not limited to such a differential. In one example, the invention may be applied to a differential whose pinion gear including a bevel gear is pivotally supported by a pinion shaft disposed at right angles to a rotation axis of a differential case. Such a differential is disclosed in JP 2017-187137 A, for example. When the invention is applied to a differential of this type, a movable member that is axially moved by an actuator restricts rotation of a pinion shaft (i.e., a rotative element) relative to a differential case.

What is claimed is:

1. A differential comprising:
a case that rotates around a rotation axis upon receiving a driving force from a driving source;
a plurality of rotative elements including a pair of output rotators housed in the case;
a movable member disposed such that the movable member is axially movable along the rotation axis inside the case, the movable member being axially movable toward one side so as to restrict rotation of one of the rotative elements relative to the case; and
an actuator to axially move the movable member, wherein
the differential is configured to differentially output, from the pair of output rotators, the driving force input to the case,
the actuator includes
an electromagnetic coil including a winding and a resin portion, the winding being molded with the resin portion,
a yoke supporting the electromagnetic coil, and
an armature that slides on an outer peripheral surface of the electromagnetic coil so as to move axially,
the yoke includes a side wall including a lateral surface that faces one of axial end faces of the electromagnetic coil,
the armature includes a cylindrical portion including an inner peripheral surface that faces the outer peripheral surface of the electromagnetic coil and an outer peripheral surface of the side wall, and
at least one of the outer peripheral surface of the side wall and the inner peripheral surface of the cylindrical portion is provided with an inclined portion inclined relative to a direction parallel to the rotation axis, the inclined portion being configured to restrict the one of the outer peripheral surface of the side wall and the inner peripheral surface of the cylindrical portion from coming into contact with the other one of the outer peripheral surface of the side wall and the inner peripheral surface of the cylindrical portion.

2. The differential according to claim 1, wherein
the inclined portion is provided on the outer peripheral surface of the side wall of the yoke, and
the inclined portion is a tapered surface inclined such that the side wall increases in diameter toward the electromagnetic coil.

3. The differential according to claim 1, wherein
the inclined portion is provided on the inner peripheral surface of the cylindrical portion of the armature, and
the inclined portion is a tapered surface inclined such that the cylindrical portion increases in inner diameter toward an extremity of the cylindrical portion.

4. The differential according to claim 1, wherein
the armature includes an annular plate extending radially inward from an end of the cylindrical portion, the annular plate facing the other one of the axial end faces of the electromagnetic coil located opposite to the side wall, and
at least a portion of an inner peripheral surface of the annular plate is a tapered surface inclined such that the annular plate increases in inner diameter toward the electromagnetic coil.
